(19) United States
(12) Patent Application Publication
(10) Pub. No.: US 2001/0038425 A1
(43) Pub. Date: Nov. 8, 2001

(54) BACKLIGHT ASSEMBLY FOR A DISPLAY DEVICE

(76) Inventor: JAMES Y. LEE, IRVINE, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/128,957

(22) Filed: Aug. 4, 1998

(51) Int. Cl. G02F 1/1335

(52) U.S. Cl. 349/61

(57) ABSTRACT

An apparatus for an improved backlight display is described. The invention includes a dimmable light source which directs light through a filter before the light from a light source is distributed by a light guide.

### BACKGROUND OF THE INVENTION

1. Field of the Invention

The present invention relates to display devices. In particular, the invention relates to an improved backlight for a display device.

2. Background Information

Display devices are used in portable computer systems, imaging systems, and other electronic devices. Many of these display devices require a source of light to illuminate a display screen. One example of a non-emissive display device that requires an external source of light is a liquid crystal display (“LCD”). LCDs typically include a liquid crystal layer containing liquid crystals which operate as light valves, allowing transmission of light in one state and blocking transmission of light in a second state. Placing a source of light or backlight behind the liquid crystal display and electronically controlling the switching of the light valves allows a user viewing the front of the LCD to read text or images formed by the switched light valves. By improving the contrast ratio and brightness of the backlight, an improved display can be built. LCDs have become very popular in portable computing applications because they are rugged and require little space to operate.

One institution that extensively uses backlight display devices is the military. Military applications of such display devices require that the display devices be both rugged and meet to exacting specifications. One specification requires that the display device be adjustable through a wide range of luminance levels. Traditional methods of backlighting a display device uses fluorescent lamps that are hard to dim. Thus, an improved method of dimming a fluorescent lamp is needed.

A second military requirement is that a display device be switchable to avoid interference with a viewer's night vision. In military applications, night vision goggles enhance a user's night vision. Night vision goggles allow the wearer to see objects emitting or reflecting low frequency light, typically in the infrared spectrum. In order to avoid interfering with the performance of the night vision goggles, at night, a high pass filter is placed over the display device to block out frequencies of light which interfere with the performance of the night goggles.

These high pass filters are extremely expensive. Typically, a filter to cover a monitor may exceed $1,000. During the day, the filters significantly reduce brightness and cause color shifts. Thus, a less expensive and more efficient system that displays the output of an electronic equipment during the day and is switchable to display information at night without impairing a viewer's night vision is needed.

### SUMMARY OF THE INVENTION

The present invention describes a backlight assembly for a display device. The backlight assembly includes a light source, a filter that filters out predetermined wavelengths of light emitted by the light source, and a light-guide to guide the filtered light to illuminate the display device.

### BRIEF DESCRIPTION OF THE DRAWINGS

FIG. 1 shows a display device as used in a typical computing application.

FIG. 2 is a side cross-sectional view of one embodiment of the display device.

FIG. 3A, FIG. 3B, FIG. 3C and FIG. 4C illustrate detailed cross-sectional views of one embodiment of a light source and a filter used in conjunction with the light source.

FIG. 4 illustrates a disassembled view of a back plane device including a light guide and an accompanying diffusers.

### DETAILED DESCRIPTION

The following description describes an improved backlight assembly for use in a display device. In the following description, a number of details describing the construction and use of the display device will be described. Such details include use of the backlight assembly in a liquid crystal display, use of light guide to distribute light from an improved light source, and specific filter types used to filter light from the light source. These details are included to facilitate understanding of the invention and to describe various embodiments and ways in which the invention can be used or implemented. They should not be interpreted to limit the scope of the invention.

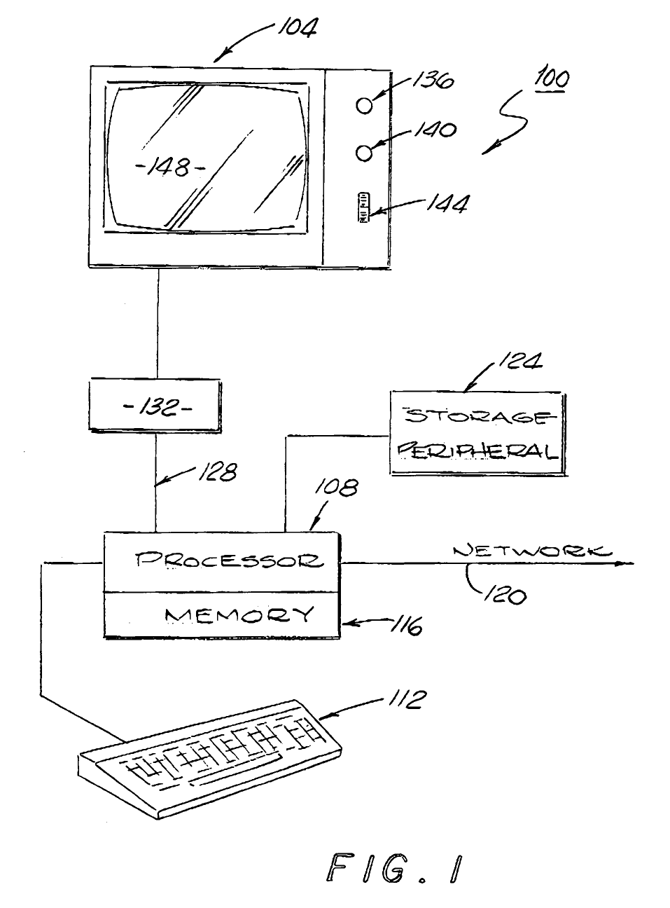

FIG. 1 illustrates a typical use of the invention. In FIG. 1, a system 100 including a display device 104 is illustrated. A processor 108 or other electronic computing mechanism processes data received from input devices such as keyboard 112 or data stored in memory 116. Data may also be received from a network along input line 120, or from storage peripherals 124 such as hard drives, tape drives or optical recording devices. Peripheral electronics such as sensors, radar detection devices, or other computers on the network may also provide data to processor 108.

Processor 108 processes the data received and produces an output signal along output line 128. In one embodiment of the invention, a video processing mechanism 132 which may include video processing circuitry converts the processor output into a suitable video signal for the display device 104. In alternative embodiments, the processor output may be routed directly to the display device 104 for output to an end user. Display device 104 may also be used directly display transmission signals without using a processor. An example of such a device is a television set in which display device 104 receives signals directly from a transmission source and displays the resulting transmission without routing the signal to a processor.

Display device 104 may include controls such as brightness controls 136 and contrast controls 140. A switch 144 adjusts display device 104 to adapt between a day mode and a night mode. In the night mode, display device 104 displays images at night with predetermined frequencies of light filtered out to minimize impairment of a viewer's night vision. A light source provides backlighting for display device 104. Brightness control 136 and contrast control 140 in cooperation with other switches on display device 104 control the light output of the light source. In one embodiment of the display device, a screen 148 of display device 104 is a non-emissive display device that requires back-lighting for luminescence. An example of a typical screen in a display device is a liquid crystal display screen. Liquid crystal display screens are well understood in the art.

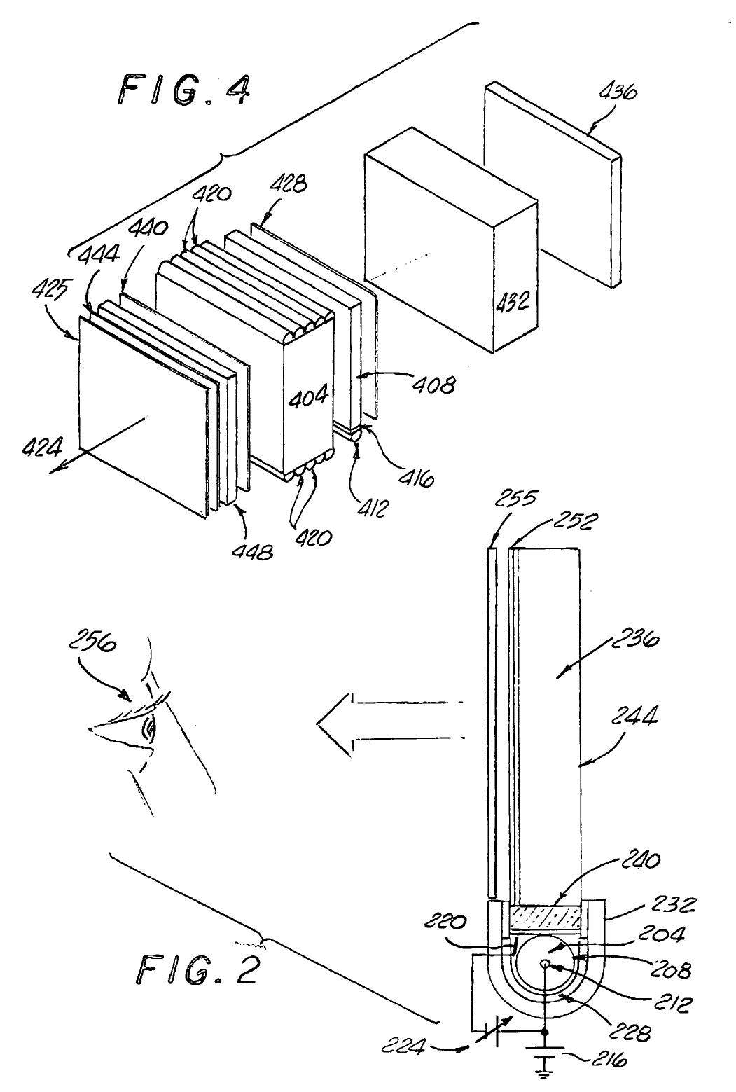

FIG. 2 illustrates a side cross-sectional view of one embodiment of display device 104. Light source 204 generates light for use in display device 104. In one embodiment of the invention, light source 204 is a fluorescent lamp. The light source 204 typically includes a transparent enclosure 208 which encloses a gas such as neon gas or other appropriate gaseous or liquid compound that emits light when subject to an electric potential. The transparent enclosure 208 is typically formed in a tube shape from a glass or a plastic material, although other materials and geometric structures may be used.

Central electrode 212 applies an electric potential to the gas within transparent enclosure 208. Typically, two central electrodes are coupled to opposite ends of the transparent enclosure 208. In one embodiment of the invention, transparent enclosure 208 is a tube and two central electrodes 212 are inserted into opposite ends of the tube, thus a first central electrode is inserted into a first or near end of the transparent enclosure 208 and a second central electrode is inserted into a far end of the transparent enclosure 208. An electric potential from a power source 216 energizes the gas contained within the transparent enclosure 208 causing fluorescence and outputting of light.

In one embodiment of the invention, dimming electrodes 220 are positioned close to the central electrodes but outside of the transparent enclosure 208. When a first central electrode and a second central electrode are applied to opposite ends of a transparent tube, two dimming electrodes may be used. A first dimming electrode is applied at a first end adjacent to a corresponding central electrode 212 at a first end. At the second end of transparent enclosure 208, a second dimming electrode is positioned close to a corresponding central electrode at the second end of transparent enclosure 208.

The dimming electrodes provide an electric potential gradient between dimming electrode 220 and a corresponding central electrode 212. The electric potential difference between dimming electrode 220 and a corresponding central electrode 212 may be controlled by a brightness or dimming switch. In one embodiment, a first central electrode at a first end of the transparent enclosure is electrically connected to the dimming electrode at the second end of the transparent enclosure such that the potential between the central electrodes is the same as the potential difference between a central electrode and a corresponding dimming electrode. In a second embodiment, a dimming switch controls an adjustable power source 224 that controls the electric potential between corresponding central electrode 212 and dimming electrode 220.

A reflective film 228 surrounds one side of light source 204. The reflective film 228 may be housed within a support structure 232 which provides protection to light source 204. In one embodiment, Gore material with a thickness of approximately 0.25 mm thickness manufactured by W. L. Gore & Associates, Inc., 100 Airport Road, P.O. Box 1010, Elkton, Md. 21922, or other highly reflective polished surface which reflects light from light source 204 towards a light guide 236 may be used for reflective film 228. By reflecting light from light source 204 to light guide 236, the efficiency of the light source can be improved.

In one embodiment of the invention, before light from light source 204 reaches light guide 236, a filter 240 filters the light from light source 204. Filter 240 filters out undesirable wavelengths of light. A typical filter 240 is a high filter that prevents light wavelength exceeding a predetermined wavelength from passing through the filter. One example of such a filter is a NVIS filter produced by commercial manufacturers such as NV-FLC-2 filters from Wamco of 11555-A Coley River Circle, Fountain Valley, Calif. 92708. Light guide 236 receives the filtered light from filter 240 and distributes the filtered light along a back plane 244 of the display device. A significant portion of the light in the backplane 244 is reflected towards the viewer by means of total internal reflection. In one embodiment of the invention, light output from light guide 236 passes through a diffuser 252 before passing through a display such as a liquid crystal display 255 that contains a series of light valves. The display is viewed by an observer or viewer 256.

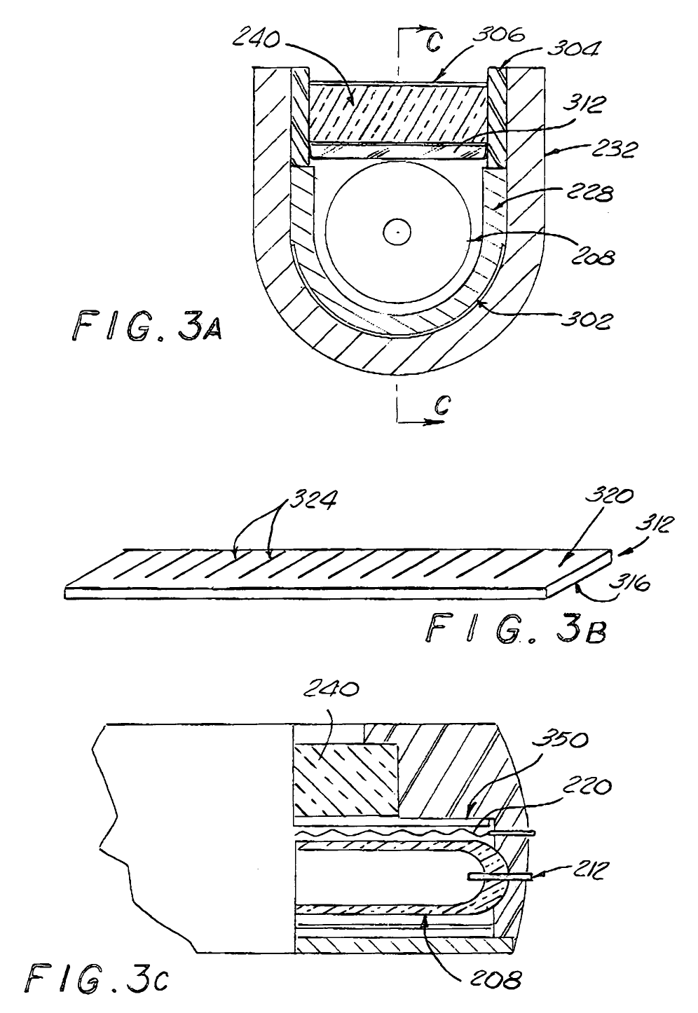

FIG. 3A is an expanded view of the light source illustrating additional details of the construction. In FIG. 3A, transparent enclosure 208 is closely surrounded by reflective film 228. A metal support structure 232 surrounds reflective film 228 and provides support to reflective film 228. In one embodiment, tape or other adhesive 302 inserted between reflective film 228 and support structure 232 affixes the reflective film to the support structure.

In one embodiment of the invention, an epoxy 304 fixes a filter 240 to the support structure 232. Support structure 232 reflects or channels light towards the filter and also acts as a support structure. One example of a typical filter utilizes a coating 306 on the surface of glass to sharply cut off light having wavelengths longer than 600 nanometers. A high pass filter which cuts off light having a wavelength longer than 600 nanometers serves as an excellent night vision filter. Although other cutoffs may be chosen, 600 nanometers is optimum to avoid interference with the performance of typical military night vision goggles. These goggles are typically sensitive to light above 600 nanometers. In one embodiment of the invention, filter 240 also includes a brightness enhancement filter 312 (“BEF”). BEF 312 redirects light from the light source in a direction approximately perpendicular to the surface of the BEF.

FIG. 3B illustrates an expanded view of the BEF. Typically, BEF filter 312 has a smooth surface 316 on one side and a grooved surface 320 on a second side. The grooves 324 in the BEF filter help direct the light such that light passing through the BEF exits the BEF in a direction approximately perpendicular to the surface of BEF 312, facilitating the coupling of light into light guide 236 of FIG. 2.

FIG. 3C illustrates a side view of one end of the light source. FIG. 3C illustrates one central electrode 212 and a corresponding dimming electrode 220. An insulator 350 prevents electrical contact between the dimming electrode and the surrounding support structure. The support structure is typically made of metal, however, the support structure may also be made from nonconductive material. When the support structure is made from a nonconductive material, insulator 350 is not needed. Insulator 350 prevents shorting of the two dimming electrodes positioned at opposite ends of the light source. Dimming electrode 220 in the illustrated embodiment extends along one side outside of transparent enclosure 208. Filter 240 is shown above transparent enclosure 208.

Standard fluorescent lamps can be dimmed only to a predetermined luminance before the electric field between the two central electrodes is insufficient to steadily excite the fluorescent gas and the lamp begins to flicker. Dimming electrode 220 at either end assists in further dimming the fluorescent lamp to a lower luminance before flickering occurs. This is achieved because the close proximity of the dimming electrode and a corresponding central electrode creates a short gap. The short gap between electrodes creates high electric fields at a given voltage increasing the probability of light emissions of a fluorescent gas.

FIG. 3D illustrates one embodiment of the invention, four electrodes including two central electrodes 360, 365 and two dimming electrodes 370, 375 are used. At a first end 380 of the light 385, a first central electrode 360 and a corresponding first dimming electrode 370 are implemented. At an opposite second end 390, a second central electrode 365 and a corresponding second dimming electrode 375 are implemented. An alternating current (AC) power source 392 provides power to the central electrodes and dimming electrodes. The circuit is configured such that the potential difference between the two central electrodes 360, 365 is the same as the potential difference between a central electrode 360 and a corresponding dimming electrode 370.

In one embodiment, the AC power source 392 provides approximately 3000 volt peak to peak alternating voltage signal. The duty cycle or period of when a high voltage is applied is adjusted to correspond to the light output desired. When dimming is desired, the duty cycle or period of high voltage is reduced to time periods of approximately 25 microseconds. During such short time periods (short voltage pulses), the electric field between the central electrodes 360, 365 determined by Electric field =(Voltage difference/distance between central electrodes) may be insufficient to insure excitation of the fluorescent gas, thus lamp flickering occurs due to voltage pulses that fail to excite the fluorescent gas. Excitation is determined by a probability function that increases with the strength of the electric field and the time that the electric field is applied. However, the short distance between a central electrode 365 and a corresponding dimming electrode 375 results in high electric field levels which insures that even during short time periods (short voltage pulses) the fluorescent gas has a high probability of excitation and light output.

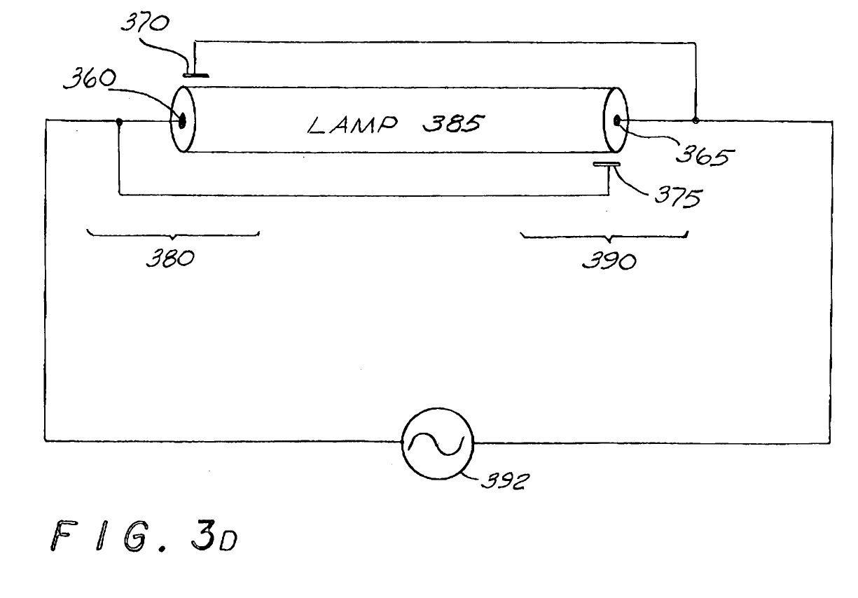

FIG. 4 illustrates an expanded version of the light guide and surrounding structure of display device 104. In the illustrated embodiment, two light guides, a day light guide 404 and a night light guide 408, are used. Night light guide 408 is coupled to a single light source 412 including a filter 416. Filter 416 includes a high pass filtering that filters unwanted wavelengths of light at the source before distribution into night light guide 408. Day light guide 404 is coupled to a plurality of light sources 420 which provides substantial illumination. In one embodiment, light sources 420 coupled to both ends of day light guide 404 provides light to day light guide 404.

The light guides may be made of glass, plastic or a number of different materials. Ideally, the light guides receive light at one end and distribute light evenly across an approximately planer surface. The light guide may include embedded light scatterers. Light scatterers may be small particles, strands of material, voids, bubbles, or random imperfections embedded in the light guide. The light scatterers should be distributed such that light entering from an end of the light guide exits approximately uniformly across a plane the light guide. Typically a low density of light scatterers are used.

In order to improve light output in direction 424, a reflective film 428 is positioned in a plane behind the light guides. Reflective film 428 improves the brightness of light emitted in direction 424. Behind reflective film 428 a printed circuit assembly 432 (“PCA”) provides electronics for the display and an adapter plate 436 affixes the back lighting structure to the back of a display device.

Before light is output in direction 424 from light guides 404 and 408, light passes through other filters and diffusers. A LCD display containing electronic light values controlled by PCA 432 may be inserted between the light guides and an observer. In one embodiment of the invention, additional filters may be used such as a bright enhancement filter 440 or an image directing filter 444. Front plate 448 provides protection for the display device. A diffuser 425 diffuses the light to approximately uniformly illuminate the LCD display.

In one embodiment of the invention, a day/night switch on the display device controls switching between night light sources 412 and day light sources 420. By positioning filters used only at night between night light guide 408 and night light source 412, an end user does not have to carry a filter to cover the entire frontal surface of the light guide and remove the filter during day light hours, thereby eliminating a potential storage problem for night filters. An additional advantage is the significant cost savings achieved by using substantially less filter material. By placing the filter adjacent to the light source, only a thin strip of filter material is required. Placement of the filter over the entire viewing area requires a large sheet of filter material to cover the entire front surface of the light guide.

A number of examples have been illustrated in the preceding discussion; however, the specific examples prepared were presented for illustrative purposes and should not be interpreted to limit the invention. A limitation of the invention should be interpreted in terms of the claims as follows:

What is claimed is:

1. A backlight assembly for a display device comprising:
a light source;
a light filter to filter light from the light source;
a light guide to receive light from the light filter, the light guide to provide background light for a display device.

2. The backlight assembly of claim 1 further comprising:
a diffuser coupled to a first side of the light guide to diffuse the background light for the display device.

3. The backlight assembly of claim 1 further comprising:
a reflective film coupled to a first side of the light guide, the reflective film to increase the intensity of light output by a second side of the light guide.

4. The backlight assembly of claim 1 wherein the light filter includes a high pass filter which reduces by at least 75% the intensity of light having a wavelength longer than 600 nanometers.

5. The backlight assembly of claim 1 wherein the light filter includes a brightness enhancement filter.

6. The backlight assembly of claim 1 wherein the light source includes a fluorescent light source.

7. The backlight assembly of claim 6 wherein the fluorescent light source is adjustable and further comprises:
a central electrode within an enclosure of the fluorescent light source;
a first dimming electrode at a first end of the lamp, the first dimming electrode positioned outside the enclosure.

8. The backlight assembly of claim 7 further comprising:
a second dimming electrode positioned at a second end of the lamp, the second dimming electrode positioned outside the enclosure such that by changing the potential of the first dimming electrode and the second dimming electrode, the output of the fluorescent lamp may be adjusted.

9. A light source to provide light to a backlight assembly comprising:
a transparent enclosure to confine a fluorescent gas;
a first central electrode and a second central electrode within the transparent enclosure, the first and second central electrode to provide an electric potential to excite the fluorescent gas at high light output levels; and
a first dimming electrode positioned outside the transparent enclosure, the difference in the electric potential between the first dimming electrode and the first central electrode to excite the fluorescent gas at low light output levels.

10. The light source of claim 9 further comprising: a second dimming electrode positioned outside the transparent enclosure, the difference in electric potential between the second dimming electrode and a second central electrode to determine the light output of the light source.

11. The light source of claim 9 further comprising:
a reflector surrounding the transparent enclosure to increase light intensity output from an opening in the reflector; and
a high pass filter positioned over the opening.

12. The light source of claim 11 further comprising a light guide coupled to the opening to distribute light filtered by the high pass filter across a backplane of a display device.

13. A light source of claim 11 further comprising a brightness enhancing filter positioned over the opening.

14. A display device comprising:
a light source;
a light filter to receive light from the light source and output filtered light;
a light guide to distribute the filtered light across a backplane of the display device; and
an electronically controllable medium to generate images, the electronically controllable medium illuminated by light from the light guide.

15. The display device of claim 14 further comprising a diffuser coupled to the liquid crystal medium to diffuse external light reaching the liquid crystal medium.

16. The display device of claim 14 wherein the electronically controllable medium is a liquid crystal display.

17. A display device comprising:
a first source of light coupled to a day light guide to provide a high level of background lighting for the display device;
a second source of light coupled to a filter, the filter transferring light to a night light guide to provide a low level of background lighting for the display device; and
a display screen to receive light from the day light guide when a switch is in a first position, the display screen to receive light from the night light guide when the switch is in a second position.

18. The display device of claim 17 wherein the filter is a high band pass filter.

19. The display device of claim 17 wherein the display screen is a liquid crystal display screen.
